(19) United States
(12) Patent Application Publication
(10) Pub. No.: US 2024/0023776 A1
(43) Pub. Date: Jan. 25, 2024

(54) SUCTION NOZZLE, CLEANER COMPRISING SUCTION NOZZLE, AND CONTROL METHOD OF CLEANER

(71) Applicant: LG ELECTRONICS INC., Seoul (KR)

(72) Inventor: Donghoon KWAK, Seoul (KR)

(21) Appl. No.: 18/027,442

(22) PCT Filed: Sep. 9, 2021
(86) PCT No.: PCT/KR2021/012309

§ 371 Date: Mar. 21, 2023

(30) Foreign Application Priority Data
Sep. 23, 2020 (KR) 10-2020-0123042

(51) Int. Cl. A47L 9/28; H01H 13/14; G01V 8/12; G01D 5/14; A47L 9/04

(52) U.S. Cl. CPC A47L 9/2847; H01H 13/14; G01V 8/12; G01D 5/145; A47L 9/2842; A47L 9/0477; A47L 9/2889; A47L 9/2805

(57) ABSTRACT

An embodiment provides a cleaner which comprises: a suction nozzle; and a handle, and is moved by means of the handle, wherein the suction nozzle comprises a bumper and a brush, the bumper is composed of a first side and a second side, and is disposed outside the nozzle, the second side is disposed to be spaced apart from the first side by a first distance, and the number of rotations of the brush and suction power of the cleaner are controlled according to the first distance that changes in response to the bumper being pressed.

### TECHNICAL FIELD

Embodiments herein relate to a suction nozzle, a cleaner including the suction nozzle, and a control method of the cleaner, and more particularly, to a suction nozzle of a cleaner having an improved suction force, a cleaner including the suction nozzle, and a control method of the cleaner.

### BACKGROUND ART

In general, a cleaner is a device that performs cleaning by sucking or mopping dust or foreign matter. Such a cleaner performs a cleaning function for a floor, and the cleaner includes wheels for movement. In general, the wheels are rolled by an external force applied to a cleaner body to move the cleaner body with respect to the floor.

Such a cleaner is a device that sucks air containing dust, and then filters the dust in a dust separator using a suction force generated by a suction motor mounted inside the cleaner body. The cleaner may be classified into a canister-type cleaner in which a suction nozzle for sucking dust is provided separately from a main body and connected by a connecting device, an upright-type cleaner in which the suction nozzle is rotatably connected to the main body, and a handy-type cleaner that is used while a user grips the main body with his or her hand.

In addition, the cleaner is a device that generates a suction force by driving an electric blower fan built in a housing and includes a brush, and sucks air containing foreign matter such as dust and dust that comes in by the rotation of the brush into the housing by the suction force of the air, filters them through a filter, and then discharges them to an outside of the housing for cleaning. The cleaner is classified into a canister type, an upright type, and a handy type.

Furthermore, an agitator, which is a rotating brush attached to a brush member, may be provided in the suction nozzle of the cleaner to perform cleaning while the agitator rotates to scrape dust from the floor surface or carpet.

A cleaner in the related art has a built-in sensor capable of detecting a nearby obstacle to control a rotational speed of the brush when detecting the obstacle so as to improve cleaning performance in an obstacle proximity zone. However, in the case of the cleaner in the related art, there is a problem in that even when an obstacle moves and passes near the nozzle or the user passes near the obstacle while sweeping back and force quickly, the rotation speed of the brush is changed sporadically whenever the obstacle is detected, and the rotation speed of the brush cannot be controlled at a desired time.

In addition, the cleaner in the related art has a problem in that the nozzle is easily broken due to a collision with the obstacle during use.

### PRIOR LITERATURE

U.S. Patent Publication No. US 2012-0167331

### DISCLOSURE OF INVENTION

### Technical Problem

Embodiments are intended to overcome the above-described problems, and to provide a cleaner capable of detecting a nearby obstacle.

Furthermore, embodiments are intended to provide a cleaner including a bumper resistant to damage by an obstacle. In addition, embodiments are intended to control a rotational speed of a brush motor and/or a suction motor according to detection of an obstacle, thereby improving cleaning performance in an obstacle proximity zone.

Moreover, embodiments are intended to control a rotational speed and/or a suction force of a brush for obstacle proximity zone cleaning at a time point desired by a user.

In addition, embodiments are intended to detect a contact between a nozzle of the cleaner and an obstacle, thereby improving cleaning performance in an obstacle proximity zone.

Technical problems to be solved by the embodiments are not limited to the above-mentioned problems and other technical problems which are not mentioned will definitely be understood by those skilled in the art from the description of the embodiments.

### Solution to Problem

An embodiment may provide a cleaner. There is disclosed such a cleaner including a suction nozzle and a handle, the cleaner being moved by means of the handle, wherein the suction nozzle includes a bumper and a brush, the bumper is composed of a first surface and a second surface and is disposed outside the nozzle, the second surface is disposed apart from the first surface by a first distance, and a number of revolutions of the brush and a suction force of the cleaner are controlled according to the first distance that changes in response to the pressing of the bumper.

Furthermore, according to an embodiment, the cleaner may further include a motor and a controller, the motor may control at least one of a number of revolutions of the brush and a suction force of the cleaner according to a control signal of the controller, the suction nozzle may generate a pressing signal of the bumper when the first distance is changed to a second distance according to the pressing of the first surface, and generate a pressing release signal of the bumper when a distance between the first surface and the second surface is changed from the second distance to the first distance, the controller may generate the control signal such that the number of revolutions becomes a first number revolutions according to the pressing signal and the number of revolutions becomes a second number of revolutions according to the pressing release signal, and the pressing of the first surface may be in proportion to a distance moved by means of the cleaner using the handle, the second distance may be narrower than the first distance, and the first number of revolutions may be larger than the second number of revolutions.

Furthermore, according to an embodiment, a photo interrupter may be disposed on the first surface, the photo interrupter may be defined in a horseshoe shape including a space therebetween, a light-blocking material may be disposed at a position corresponding to the space on the second surface, the light-blocking material may not enter the space at the first distance and at least part thereof may enter the space at the second distance, and the photo interrupter may generate the pressing signal in response to the first distance and generate the pressing release signal in response to the second distance.

Furthermore, according to an embodiment, the photo interrupter may include a light-emitting element and a light-receiving element, and the space may be defined between the light-emitting element and the light-receiving element, wherein the photo interrupter generates the pressing signal or the pressing release signal according to an amount of light of the light-emitting element detected by the light-receiving element. Furthermore, according to an embodiment, the photo interrupter may detect a first amount of light from the light-emitting element at the first distance, detect a second amount of light from the light-emitting device at the second distance, generate the pressing signal according to the first amount of light, and generate the pressing release signal according to the second amount of light, wherein the first amount of light is less than the second amount of light.

Furthermore, according to an embodiment, the photo interrupter may generate the pressing signal when the first amount of light is changed to the second amount of light, and generate the pressing release signal when the second amount of light is changed to the first amount of light.

Furthermore, according to an embodiment, a Hall sensor may be disposed on the first surface, a magnet may be disposed at a position corresponding to the Hall sensor on the second surface, the Hall sensor may detect a first magnetic force corresponding to the first distance and a second magnetic force corresponding to the second distance, generate the pressing release signal in response to the first magnetic force and generate the pressing signal in response to the second magnetic force, wherein the strength of the second magnetic force is stronger than that of the first magnetic force.

Furthermore, according to an embodiment, the Hall sensor may further generate the pressing signal when the first magnetic force is changed to the second magnetic force, and generate the pressing release signal when the second magnetic force is changed to the first magnetic force.

Furthermore, according to an embodiment, the bumper may include a detection circuit, the detection circuit may include a switch that performs a switching operation according to a degree of pressing of the bumper, wherein the detection circuit generates the pressing signal and the pressing release signal according to the magnitude of a current flowing through the switch.

Furthermore, according to an embodiment, the switch may perform a switching operation such that the current becomes a first current flowing through a first path in response to the first distance, and perform a switching operation such that the current becomes a second current flowing through a second path in response to the second distance, the detection circuit may further generate the depressing release signal in response to the first current and generate the pressing signal in response to the second current, wherein the intensity of the second current is lower than that of the first current.

Furthermore, according to an embodiment, the detection circuit may further generate the pressing signal when the first current is changed to the second current, and generate the pressing release signal when the second current is changed to the first current.

In addition, another embodiment may provide a suction nozzle. There is disclosed such a suction nozzle of a cleaner including a handle and a bumper, the cleaner being moved to the handle, wherein the bumper is composed of a first surface and a second surface and is disposed outside the suction nozzle, the second surface is disposed apart from the first surface by a first distance, the suction nozzle sucks outside air according to a suction force generated in response to a predetermined number of revolutions, generates a pressing signal of the bumper when the first distance is changed to a second distance according to the pressing of the first surface, generates a pressing release signal of the bumper when a distance between the first surface and the second surface is changed from the second distance to the first distance, the number of revolutions becomes a first number of revolutions according to the pressing signal and the number of revolutions becomes a second number of revolutions according to the pressing release signal, the pressing of the first surface is in proportion to a distance by which the cleaner moves using the handle, the first surface is formed of a flexible material, the second distance is narrower than the first distance, and the first number of revolutions is larger than the second number of revolutions.

Furthermore, according to another embodiment, a photo interrupter may be disposed on the first surface of the suction nozzle, and the photo interrupter may be defined in a horseshoe shape including a space therebetween, wherein a light-blocking material is disposed at a position corresponding to the space on the second surface, the light-blocking material does not enter the space at the first distance and at least part thereof enters the space at the second distance, and the photo interrupter generates the pressing signal in response to the first distance and generates the pressing release signal in response to the second distance.

Furthermore, according to another embodiment, the photo interrupter may include a light-emitting element and a light-receiving element, and the space may be defined between the light-emitting element and the light-receiving element, wherein the photo interrupter generates the pressing signal or the pressing release signal according to an amount of light of the light-emitting element detected by the light-receiving element.

Furthermore, according to another embodiment, the photo interrupter may detect a first amount of light from the light-emitting element at the first distance, detect a second amount of light from the light-emitting device at the second distance, generate the pressing signal according to the first amount of light, and generate the pressing release signal according to the second amount of light, wherein the first amount of light is less than the second amount of light.

Furthermore, according to another embodiment, the photo interrupter may generate the pressing signal when the first amount of light is changed to the second amount of light, and generate the pressing release signal when the second amount of light is changed to the first amount of light.

Furthermore, according to another embodiment, a Hall sensor may be disposed on the first surface, a magnet may be disposed at a position corresponding to the Hall sensor on the second surface, and the Hall sensor may detect a first magnetic force corresponding to the first distance and a second magnetic force corresponding to the second distance, generate the pressing release signal in response to the first magnetic force, and generate the pressing signal in response to the second magnetic force, wherein the strength of the second magnetic force is stronger than that of the first magnetic force.

Furthermore, according to another embodiment, the Hall sensor may further generate the pressing signal when the first magnetic force is changed to the second magnetic force, and generate the pressing release signal when the second magnetic force is changed to the first magnetic force.

Furthermore, according to another embodiment, the bumper may include a detection circuit, and the detection circuit may include a switch that performs a switching operation according to a degree of pressing of the bumper, wherein the detection circuit generates the pressing signal and the pressing release signal according to the magnitude of a current flowing through the switch.

Furthermore, according to another embodiment, the switch may perform a switching operation such that the current becomes a first current flowing through a first path in response to the first distance, and perform a switching operation such that the current becomes a second current flowing through a second path in response to the second distance, and the detection circuit may further generate the pressing release signal in response to the first current, generate the pressing signal in response to the second current, generate the pressing signal when the first current is changed to the second current, and generate the pressing release signal when the second current is changed to the first current, wherein the intensity of the second current is lower than that of the first current.

### Advantageous Effects of Invention

A suction nozzle of a cleaner according to an embodiment, a cleaner including the same, and a control method of the cleaner have an effect of capable of detecting a nearby obstacle.

Furthermore, there is an effect of providing a cleaner including a bumper resistant to damage by an obstacle.

In addition, a rotational speed of a brush motor and/or a suction motor according to detection of an obstacle is controlled, thereby having an effect capable of improving cleaning performance in an obstacle proximity zone.

Moreover, there is an effect capable of controlling a rotational speed and/or a suction force of a brush for obstacle proximity zone cleaning at a time point desired by a user.

In addition, there is an effect of detecting a contact between a nozzle of a cleaner and an obstacle, thereby having an effect capable of improving cleaning performance in an obstacle proximity zone.

### BRIEF DESCRIPTION OF DRAWINGS

FIG. 1 is a perspective view of a cleaner according to an embodiment.

FIG. 2A shows a side view showing a suction nozzle according to an embodiment.

FIG. 2B shows an exploded perspective view of a suction nozzle according to an embodiment.

FIG. 3 is a block diagram showing a main configuration of a cleaner according to an embodiment.

FIG. 4A is a view showing a cross section of a front bumper according to an embodiment.

FIG. 4B is a view showing the pressing of the front bumper according to an embodiment.

FIG. 5A is a view showing a cross section of a front bumper according to another embodiment.

FIG. 5B is a view showing the pressing of the front bumper according to another embodiment.

FIG. 6A is a view showing an inside of a front bumper according to still another embodiment.

FIG. 6B is a view showing an internal connection state according to the pressing of the front bumper according to still another embodiment.

FIG. 7 is a flowchart showing a control method of a cleaner according to an embodiment.

### MODE FOR THE INVENTION

Hereinafter, embodiments disclosed herein will be described in detail with reference to the accompanying drawings, and the same or similar elements are designated with the same numeral references regardless of the numerals in the drawings and their redundant description will be omitted. In general, a suffix such as “module” and “unit” may be used to refer to elements or components. Use of such a suffix herein is merely intended to facilitate description of the specification, and the suffix itself is not intended to give any special meaning or function. In describing the embodiments disclosed herein, moreover, the detailed description will be omitted when specific description for publicly known technologies to which the invention pertains is judged to obscure the gist of the embodiments disclosed in the present disclosure. Furthermore, the accompanying drawings are provided only for a better understanding of the embodiments disclosed herein and are not intended to limit technical concepts disclosed herein, and therefore, it should be understood that the accompanying drawings include all modifications, equivalents and substitutes within the concept and technical scope of the embodiments.

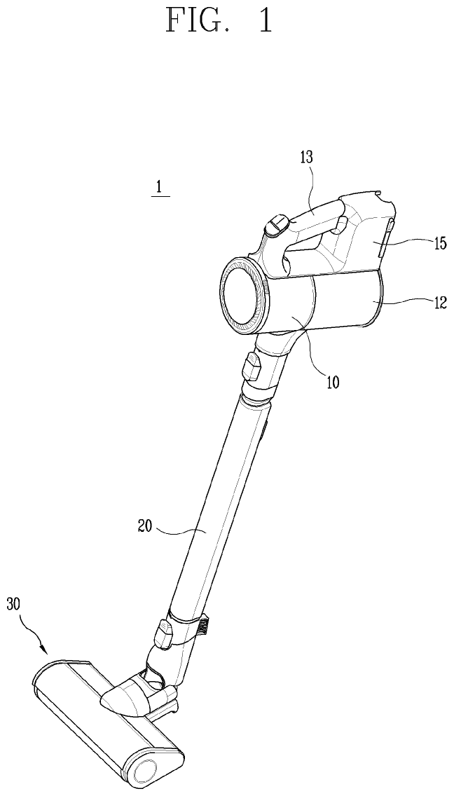

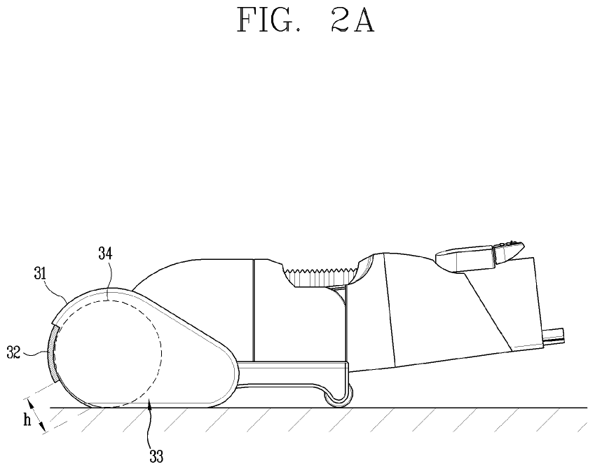

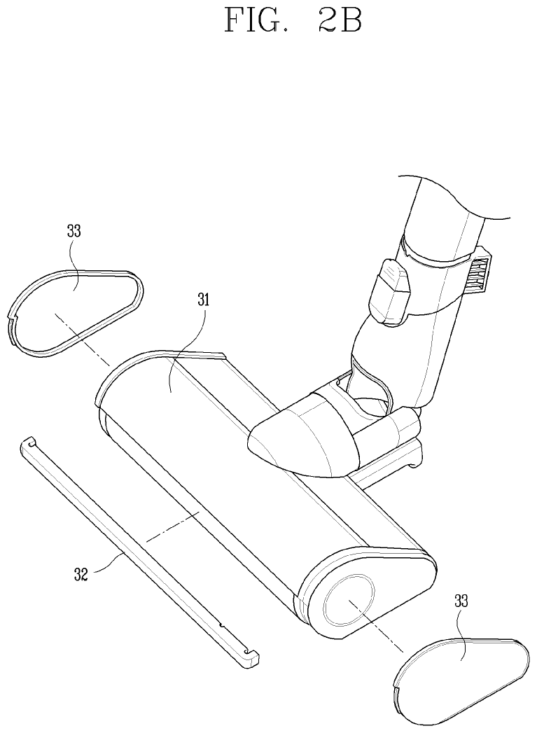

Hereinafter, a cleaner according to an embodiment will be described with reference to FIGS. 1, 2A, and 2B.

FIG. 1 is a perspective view of a cleaner according to an embodiment.

FIG. 2A shows a side view showing a suction nozzle according to an embodiment.

FIG. 2B shows an exploded perspective view of a suction nozzle according to an embodiment.

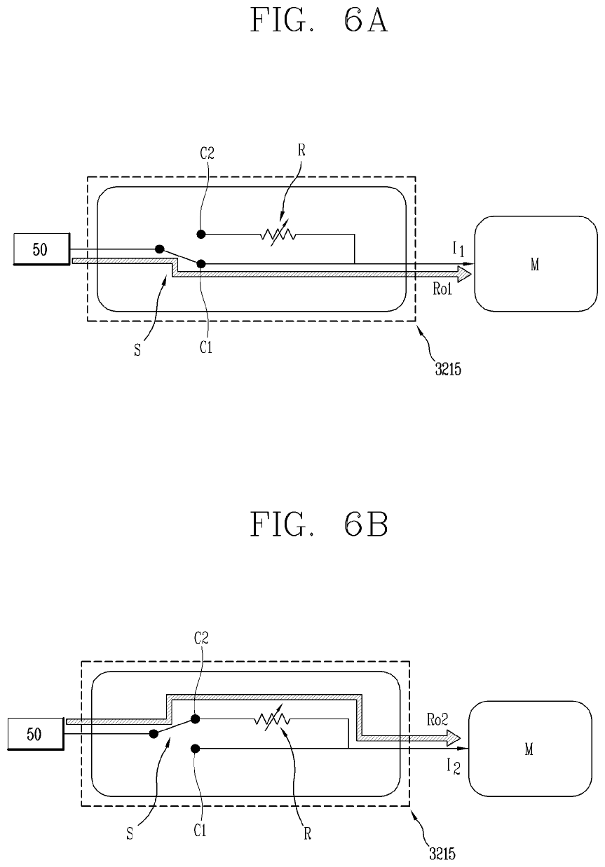

Referring to FIGS. 1, 2A, and 2B, a cleaner 1 according to an embodiment may include a cleaner body 10 having a motor M (see FIG. 6A) for generating a suction force and the rotation of a brush 34, an extension tube 20 connected between the cleaner body 10 and a suction nozzle 30, and the suction nozzle 30 that sucks air containing dust.

The cleaner body 10 may include a dust container 12 in which dust separated from air is stored. Accordingly, dust introduced through the suction nozzle 30 may be stored in the dust container 12 through the extension tube 20. A handle 13 for allowing a user to grip may be provided on the cleaner body 10. The user may perform cleaning while gripping the handle 13. The cleaner body 10 may be provided with a battery (not shown), and the cleaner body 10 may be provided with a battery receiving portion 15 for receiving the battery therein. The battery receiving portion 15 may be provided in a lower portion of the handle 13. The battery generates an air flow from the suction nozzle 30 to the dust container 12 so as to suck outside air into the dust container 12 through the suction nozzle 30 and supplies driving power to a motor M that generates rotation of the brush 34.

The extension tube 20 may be configured with a structure capable of connecting the main body 10 and the suction nozzle 30 to each other. For example, the extension tube 20 may be configured with a vacant hollow structure to transfer contaminants such as dust from the suction nozzle 30 the dust container 12. The hollow structure may define a contaminant passage between the suction nozzle 30 and the dust container 12.

The suction nozzle 30 may include a case 31, a front bumper 32, a side bumper 33, and a brush 34. The suction nozzle 30 is a nozzle through which air containing dust is sucked.

The case 31 may define an outer shape of the suction nozzle 30 and the front bumper 32 and the side bumper 33 may be mounted thereon. A front opening h may be disposed below a front side of the case 31. Contaminants may enter the suction nozzle 30 through the front opening h.

The front bumper 32 is a part mounted on a front surface of the case 31 and exposed to the outside, and is configured to be movable to an inside of the case 31 by being pressed when in contact with an obstacle (e.g., a wall or a corner). A specific function of the front bumper 32 will be described later.

The side bumpers 33 are disposed on a left side portion and a right side portion of the case 31, respectively. The side bumpers 33 may be disposed such that parts thereof protrude in a lateral direction of the case 31 while being mounted on the left side and right side portions of the case 31, respectively. That is, the side bumpers 33 may be disposed to further protrude in a lateral direction than both sides of the case 31. However, the embodiment is not limited thereto. In this case, when there is an obstacle on the side of the suction nozzle 30, the side bumper 33 may first collide with the obstacle before the front bumper 32, thereby effectively detecting the obstacle.

The brush 34 may be mounted inside the case 31 and partially exposed to the outside through the front opening h. The brush 34 may be rotated by a rotational driving force generated by the motor M. An outer peripheral surface of the brush 34 may be made of a fabric such as a carpet or a felt material. The brush 34 may rotate to rub against a surface to be cleaned to put contaminants into the suction nozzle 30. For example, when the brush 34 rotates, contaminants such as dust accumulated on the surface to be cleaned are caught on the outer peripheral surface of the brush 34, thereby allowing the contaminants to physically enter the suction nozzle 30.

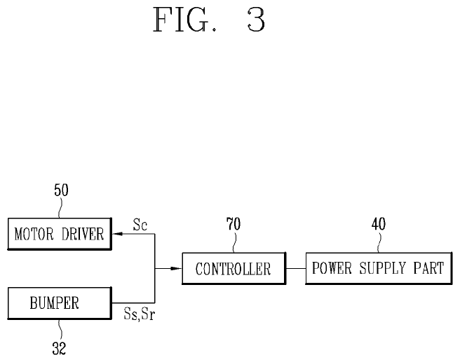

Hereinafter, a main configuration of a cleaner according to an embodiment will be described with reference to FIG. 3.

The cleaner 1 according to an embodiment includes a front bumper 32, a power supply part 40, a motor driver 50, and a controller 70.

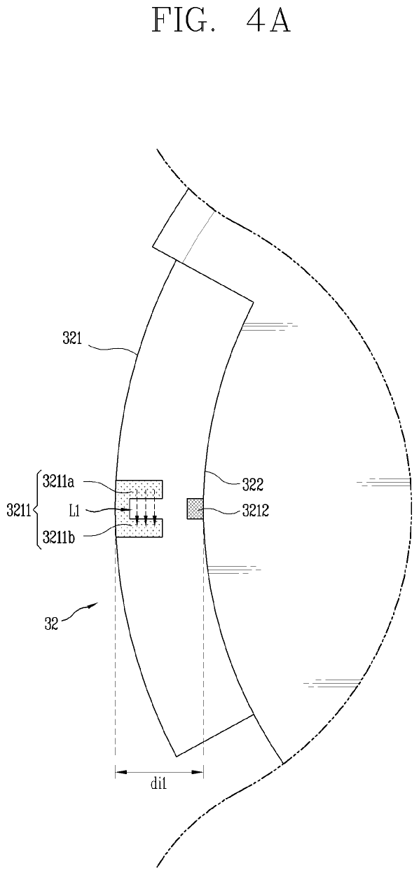

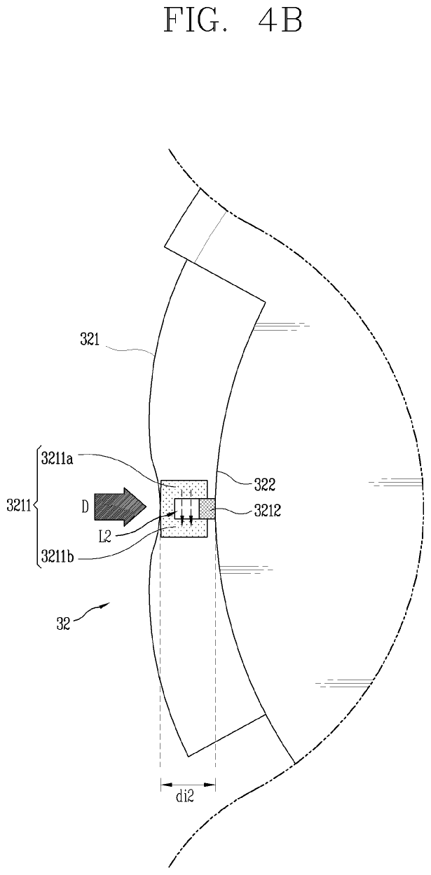

The front bumper 32 may be configured to be movable toward an inside of the case 31 in a direction D (see FIG. 4B) opposite to a direction in which the user pushes the cleaner 1 when the user pushes the cleaner 1 with a predetermined force such that the front bumper 32 comes into contact with an obstacle. An outside of the front bumper 32 may be formed of a flexible material that does not break from an external impact, such as rubber or soft plastic. Accordingly, the front bumper 32 can be protected from an impact generated when the cleaner 1 comes into contact with an obstacle in a direction in which the user pushes the cleaner 1.

Accordingly, the cleaner according to the embodiment provides a bumper capable of preventing damage due to an impact between an obstacle and a nozzle, which is generated by a user's use.

The front bumper 32 may generate a pressing signal Ss corresponding to a distance moving toward an inside of the case 31. When the user moves the cleaner 1 away from an obstacle, the front bumper 32 may generate a pressing release signal corresponding to a distance moving toward an outside of the case 31.

The power supply part 40 controls the power of the cleaner 1. The power supply part 40 may include a power switch (not shown) to generate a power signal Sp depending on whether the power switch is in an ON state or an OFF state. The power switch may be a physical switch or a touch switch, but the embodiment is not limited thereto.

The motor driver 50 generates a driving current for the motor M to control a number of revolutions RPM of the motor M according to a control signal from the controller 70 and transmits the driving current to the motor M.

The motor driver 50 may control at least one of a number of revolutions of the brush 34 and a suction force of the cleaner 1 according to a control signal Sc. For example, the motor driver 50 may generate a driving current of the motor M such that the number of revolutions of the motor M becomes a first number of revolutions or a second number of revolutions according to the control signal Sc. Accordingly, the motor driver 50 may control at least one of the number of revolutions of the brush 34 and the suction force of the cleaner 1 at a first number of revolutions or a second number of revolutions according to the control signal Sc. A detailed description of how the motor driver 50 generates a driving current for the motor M will be omitted.

The controller 70 may determine whether the power of the cleaner 1 is in an ON state or an OFF state according to the power signal Sp, and generate the control signal Sc to control the number of revolutions RPM of the motor M. For example, when the power of the cleaner 1 is in an ON state, the controller 70 may generate the control signal Sc such that the number of revolutions of the motor M becomes the first number of revolutions. Furthermore, the controller 70 may determine whether the pressing of the front bumper 32 is generated according to a pressing signal Ss to control the number of revolutions RPM of the motor according to a degree of pressing of the front bumper 32. For example, the controller 70 may detect the pressing of the front bumper 32 according to the pressing signal Ss to generate the control signal Sc such that the number of revolutions of the motor is changed from the first number of revolutions to the second number of revolutions. In this case, the second number of revolutions may be greater than the first number of revolutions, and the second number of revolutions may be increased according to the degree of pressing of the front bumper 32.

In addition, the controller 70 may detect a pressing release of the front bumper 32, and then detect the pressing release of the front bumper 32 according to a pressing releasing signal Sr to generate the control signal Sc such that the number of revolutions of the motor M is changed from the second number of revolutions to the first number of revolutions.

Furthermore, the controller 70 may control a suction force of the brush 34 and/or the suction nozzle 30 at a time point desired by the user. For example, when a pressing time of the front bumper 32 lasts longer than a reference time (e.g., 0.5 second), the controller 70 may recognize a user's intention (e.g., an intention to clear an obstacle proximity zone) as a time point at which the user wants more powerful cleaning). The controller 70 may recognize the user's intention to determine a current cleaning zone as an obstacle proximity zone, and perform cleaning in an obstacle proximity zone cleaning mode.

The obstacle proximity zone cleaning mode may refer to a mode in which cleaning is performed by increasing the number of revolutions of the motor M. For example, the controller 70 may increase the number of revolutions of the motor M from the first number of revolutions to the second number of revolutions when the pressing time of the front bumper 32 lasts longer than the reference time. Accordingly, the controller 70 may improve the suction force of the brush 34 and/or the suction nozzle 30 in an obstacle proximity zone cleaning mode. In this case, the second number of revolutions may be a power mode when the first number of revolutions is a normal mode, and the second number of revolutions may be a turbo mode when the first number of revolutions is a power mode, but the embodiment is not limited thereto. Here, the normal mode is a mode in which cleaning is performed by the number of revolutions of the motor M corresponding to a case where power is supplied to the cleaner 1 for the first time, the power mode is a mode in which cleaning is performed by the number of revolutions of the motor M faster than that of the normal mode, and the turbo mode is a mode in which cleaning is performed by the maximum number of revolutions of the motor M, but the embodiment is not limited thereto.

Accordingly, the cleaner 1 according to an embodiment may recognize the user's intention to control the number of revolutions of the motor M for obstacle proximity zone cleaning at a time point desired by the user.

A detailed method of detecting, by the controller 70, the pressing and pressing release of the front bumper 32 to control the number of revolutions of the motor M according to the pressing and pressing release of the front bumper 32 will be described later.

Hereinafter, a method of detecting, by a bumper and a controller, the pressing and pressing release of the bumper according to an embodiment will be described in detail with reference to FIGS. 4A and 4B.

FIG. 4A is a view showing a cross section of a bumper according to an embodiment.

FIG. 4B is a view showing the pressing of the bumper according to an embodiment.

Referring to FIGS. 4A and 4B, the front bumper 32 according to AN embodiment may be composed of a first surface 321 and a second surface 322. The first surface 321 and the second surface 322 may be disposed apart from each other by a first distance di1. The first surface 321 is disposed at an outside of the front bumper 32, and the first surface 321 and the second surface 322 define an outer shape of the front bumper 32.

The first surface 321 may be formed of a flexible material such as rubber or soft plastic. When the front bumper 32 comes in contact with an obstacle, the first surface 321 may be pressed in a first direction D toward the second surface 322 from the first surface 321 to deform the shape.

The first direction D may be a direction in which the user moves the cleaner 1 using the handle 13, and the pressing of the first surface 321 may be in proportion to a distance by which the user moves the cleaner 1 using the handle 13 or the user's force transmitted from the handle 13.

Furthermore, when the front bumper 32 comes in contact with an obstacle and then the contact is released, the shape of the first surface 321 may be restored in a direction opposite to the first direction D. For example, when the front bumper 32 comes in contact with an obstacle, the first surface 321 may from the pressing of the bumper in the first direction D according to the pressure of a contact surface thereof. In addition, after the first surface 321 forms the pressing of the bumper, the pressing of the bumper may be released in a direction opposite to the first direction D according to the release of the contact.

A photo interrupter 3211 may be disposed inside the first surface 321, and a light-blocking material 3212 may be disposed on the second surface 322 facing the photo interrupter 3211.

The photo interrupter 3211 may be defined in a horseshoe shape in which a light-emitting element 3211a and a light-receiving element 3211b are disposed to face each other. The photo interrupter 3211 may generate a pressing signal Ss or a pressing release signal Sr according to the intensity of light from the light-emitting element 3211a detected by the light-receiving element 3211b.

The light-blocking material 3212 may be disposed on the second surface 322 corresponding thereto between the light-receiving element 3211a and the light-emitting element 3211b so as to enter or exit the photo interrupter 3211. The light-blocking material 3212 may block at least part of light emitted from the light-emitting element 3211a according to the pressing of the bumper formed on the first surface.

The light-emitting element 3211a emits light toward the light-receiving element 3211b. The light-emitting element 3211a may be an infrared LED having a predetermined wavelength. For example, the light-emitting element 3211 may be an infrared LED having a wavelength of 950 nm to 850 nm, but the embodiment is not limited thereto.

The light-receiving element 3211b may generate a detection current corresponding to the intensity of light from the light-emitting element 3211. The light-receiving element 3211b may generate a pressing signal Ss or a pressing release signal Sr according to the detection current. For example, when the pressing of the bumper is generated (when the first surface 321 and the second surface 322 are spaced apart by the first distance di1), the light-receiving element 3211a may receive first light L1 of the light-emitting element 3211a. The light-receiving element 3211b may generate a pressing release signal Sr according to the light amount of the first light L1.

In addition, when the pressing of the bumper is generated in the first direction D (when the first surface 321 and the second surface 322 are spaced apart by a second distance di2), the light-receiving element 3221b may receive second light L2 of the light-emitting element 3211a. The light-receiving element 3211b may generate a pressing signal Ss corresponding to the light amount of the second light L2. At this time, at least part of the light-blocking material 3212 is inserted into a space between the light-receiving element 3211a and the light-emitting element 3211b. At this time, the second distance di2 is narrower than the first distance di1, and the light amount of the second light L2 is less than that of the first light L1.

That is, the light-receiving element 3211b may generate a pressing signal Ss or a pressing release signal Sr according to the light amount of the second light L2. In addition, the light-receiving element 3211b may generate a pressing signal Ss when the light amount of incoming light is changed from the light amount of the first light L1 to the light amount of the second light L2. The light-receiving element 3211b may generate a pressing release signal Sr when the light amount of the incoming light is changed from the light amount of the second light L2 to the light amount of the first light L1.

Accordingly, the light-receiving element 3221b may generate a pressing signal Ss corresponding to the second light L2 and then generate a pressing release signal Sr when the pressing of the bumper is not generated. Accordingly, the light-receiving element 3221b may generate a pressing signal Ss or a pressing release signal Sr according to a degree of pressing of the front bumper 32.

For convenience of description, the light received by the light-receiving element 3211b according to an embodiment has been described as two cases of the first light L1 and the second light L2, but the embodiment is not limited thereto, and the intensity of light received by the light-receiving element 3211b may be changed according to the degree of pressing of the front bumper 32. In addition, although it has been described that the photo interrupter 3211 is included inside the front bumper 32 according to an embodiment, the embodiment is not limited thereto and a photo reflector may be included inside the front bumper 32.

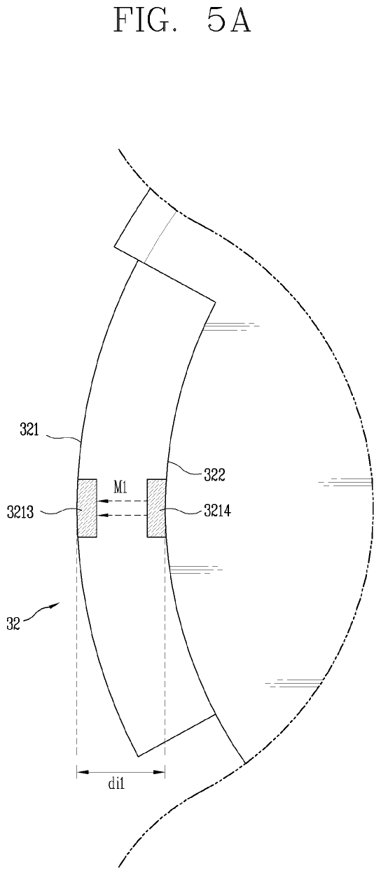

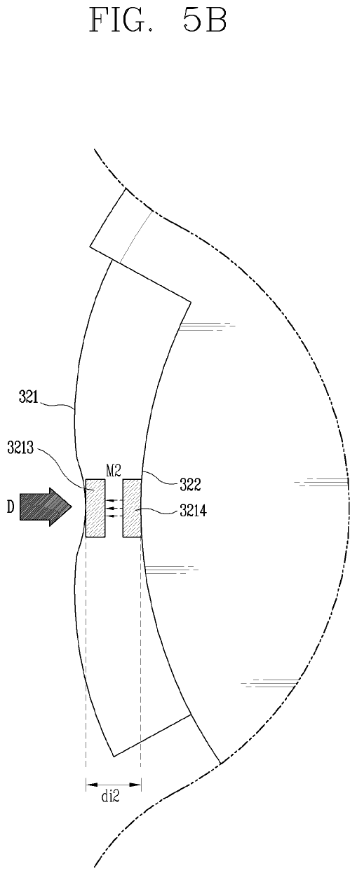

Hereinafter, a method of detecting, by a bumper and a controller, the pressing and pressing release of the bumper according to another embodiment will be described in detail with reference to FIGS. 5A and 5B.

FIG. 5A is a view showing a cross section of a bumper according to another embodiment.

FIG. 5B is a view showing the pressing of the bumper according to another embodiment.

Referring to FIG. 5A, the front bumper 32 according to another embodiment may be composed of the first surface 321 and the second surface 322. The first surface 321 and the second surface 322 may be disposed apart from each other by a first distance di1. The first surface 321 and the second surface 322 define an outer shape of the front bumper 32.

The first surface 321 may be formed of a flexible material such as rubber or soft plastic. When the front bumper 32 comes in contact with an obstacle, the shape of the first surface 321 may be deformed in a first direction D toward the second surface 322 from the first surface 321. Furthermore, when the front bumper 32 comes in contact with an obstacle and then the contact is released, the shape of the first surface 321 may be restored in a direction opposite to the first direction D. For example, when the front bumper 32 comes in contact with an obstacle, the first surface 321 may from the pressing of the bumper in the first direction D according to the pressure of a contact surface thereof. In addition, after the first surface 321 forms the pressing of the bumper, the pressing of the bumper may be released in a direction opposite to the first direction D according to the release of the contact.

A Hall sensor 3213 may be disposed inside the first surface 321, and a magnet 3214 may be disposed on the second surface 322 facing the Hall sensor 3213.

The Hall sensor 3213 may detect a magnetic force of the magnet 3214. The magnetic force is in proportion to a distance between the Hall sensor 3213 and the magnet 3214. The Hall sensor 3213 may generate a pressing signal Ss or a pressing release signal Sr according to the strength of the detected magnetic force. For example, when the pressing of the bumper is not generated (when the first surface 321 and the second surface 322 are spaced apart by a first distance di1), the Hall sensor 3213 may detect a first magnetic force M1 corresponding to the first distance di1. The Hall sensor 3213 may generate a pressing release signal Sr according to the first magnetic force M1.

In addition, when the pressing of the bumper is generated in the first direction D (when the first surface 321 and the second surface 322 are spaced apart by a second distance di2), the Hall sensor 3213 may detect a second magnetic force M2 of the magnet 3214. The Hall sensor 3213 may generate a pressing signal Ss corresponding to the second magnetic force M2. At this time, the second distance di2 is narrower than the first distance di1, and the second magnetic force M2 is stronger than the first magnetic force M1.

In addition, the Hall sensor 3213 may generate a pressing signal Ss corresponding to the second magnetic force M2 and then generate a pressing release signal Sr when the pressing of the bumper is not generated. That is, the Hall sensor 3213 may generate a pressing signal Ss or a pressing release signal Sr according to the detected magnetic force. For example, the Hall sensor 3213 generates a pressing signal Ss when the detected magnetic force is the second magnetic force M2. In addition, the Hall sensor 3213 generates a pressing signal Ss when the detected magnetic force is changed from the first magnetic force M1 to the second magnetic force M2. The Hall sensor 3213 generates a pressing release signal Sr when the detected magnetic force is the first magnetic force M1. In addition, the Hall sensor 3213 generates a pressing release signal Sr when the detected magnetic force is changed from the second magnetic force M2 to the first magnetic force M1.

Accordingly, the Hall sensor 3213 may generate a pressing signal Ss or a pressing release signal Sr according to a degree of pressing of the front bumper 32.

For convenience of description, the magnetic force detected by the Hall sensor 3213 according to the embodiment has been described as two cases of the first magnetic force M1 and the second magnetic force M2, but the embodiment is not limited thereto, and the strength of magnetic force detected by the Hall sensor 3213 may be changed according to a degree of pressing of the front bumper 32.

Hereinafter, a method of detecting, by a bumper and a controller, the pressing and pressing release of the bumper according to still another embodiment will be described in detail with reference to FIGS. 6A and 6B.

FIG. 6A is a view showing an inside of a bumper according to still another embodiment.

FIG. 6B is a view showing an internal connection state according to the pressing of the bumper according to still another embodiment.

Referring to FIGS. 6A and 6B, the front bumper 32 according to another embodiment may include a detection circuit 3215.

The detection circuit 3215 is electrically connected between the motor driver 50 and the motor M, and detects a driving current of the motor M. The detection circuit 3215 generates a pressing signal Ss and a pressing release signal Sr according to the detected driving current. The detection circuit 3215 includes a variable resistor R and a switch S.

A resistance of the variable resistor R may be changed in response to a degree of pressing of the front bumper 32. For example, the resistance of the variable resistor R may vary according to a distance between the first surface 321 and the second surface 322. Specifically, the resistance of the variable resistor R may change in proportion to or inverse proportion to the distance between the first surface 321 and the second surface 322.

The switch S is connected between the motor driver 50 and a first contact C1 or a second contact C2 to connect between the motor driver 50 and the first contact C1 or the second contact C2 as the front bumper 32 comes in contact with an obstacle.

For example, when the pressing of the bumper is not generated (when the first surface 321 and the second surface 322 are spaced apart by a first distance di1), the switch S may connect between the motor driver 50 and the first contact C1. Accordingly, a first driving current 11 is supplied to the motor M along a first path Ro1 including the motor driver 50 and the first contact C1.

In addition, when the pressing of the bumper is generated in the first direction D (when the first surface 321 and the second surface 322 are spaced apart by a second distance di2), the switch S may connect between the motor driver 50 and the second contact C2. Accordingly, a second driving current 12 is supplied to the motor M along a second path Ro2 including the motor driver 50 and the second contact C2. At this time, the second distance di2 is narrower than the first distance di1. Since a voltage drop occurs due to the variable resistor R, the second driving current 12 is lower than the first driving current 11. At this time, the resistance of the variable resistor R may vary in proportion to or inverse proportion to the distance between the first surface 321 and the second surface 322.

Accordingly, the detection circuit 3215 may generate a pressing signal Ss or a pressing release signal Sr according to a change in a distance between the first surface 321 and the second surface 322. For example, the detection circuit 3215 may generate a pressing signal Ss when the first driving current 11 is changed to the second driving current 12, and generate a pressing release signal Sr when the second driving current 12 is changed to the first driving current 11.

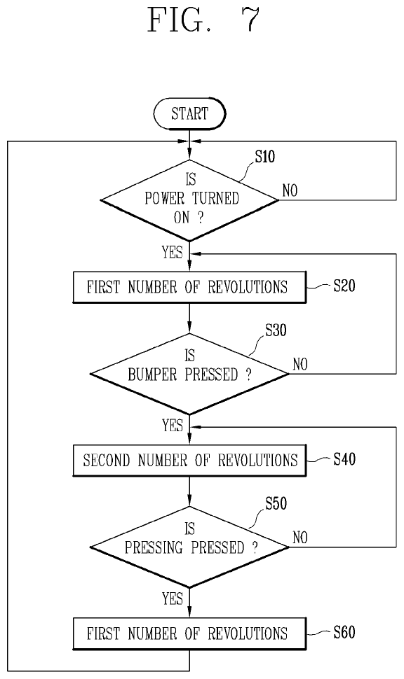

Hereinafter, a control method of a cleaner according to an embodiment will be described with reference to FIG. 7.

FIG. 7 is a flowchart showing a control method of a cleaner according to an embodiment.

In step S10, the controller 70 determines the power state of the cleaner 1 according to a power signal Sp.

In step S20, the controller 70 generates a control signal Sc so that the motor M rotates at a first number of revolutions when the power of the cleaner 1 is in an ON state.

In step S30, the controller 70 determines whether the pressing of the front bumper 32 is generated according to the pressing signal Ss.

For example, as described with reference to FIG. 4B, the photo interrupter 3211 may be defined in a horseshoe shape. That is, the photo interrupter 3211 may be defined in a horseshoe shape to form a predetermined space between the light-emitting element 3211a and the light-receiving element 3211b. The photo interrupter 3211 generates a pressing signal Ss according to the intensity of light detected by the light-receiving element 3211b, that is, the amount of light from the light-emitting element 3211a. That is, the light-receiving element 3211b may generate the pressing signal Ss according to the light amount of the second light L2. In addition, the light-receiving element 3211b generates a pressing signal Ss when the light amount of incoming light is changed from the light amount of the first light L1 to the light amount of the second light L2.

The controller 70 determines that the pressing of the front bumper 32 is generated according to the pressing signal Ss of the photo interrupter 3211.

In addition, as described with reference to FIG. 5B, the Hall sensor 3213 may detect a magnetic force of the magnet 3214. The magnetic force is in proportion to a distance between the Hall sensor 3213 and the magnet 3214. The Hall sensor 3213 may generate a pressing signal Ss according to the strength of the detected magnetic force.

That is, the Hall sensor 3213 may generate a pressing signal Ss according to the detected magnetic force. For example, the Hall sensor 3213 generates a pressing signal Ss when the detected magnetic force is the second magnetic force M2. Furthermore, the Hall sensor 3213 generates a pressing signal Ss when the detected magnetic force is changed from the first magnetic force M1 to the second magnetic force M2.

The controller 70 determines that the pressing of the front bumper 32 is generated according to the pressing signal Ss of the Hall sensor 3213.

In addition, as described with reference to FIG. 6B, the detection circuit 3215 may generate a pressing signal Ss or a pressing release signal Sr according to a change in a distance between the first surface 321 and the second surface 322. For example, the detection circuit 3215 generates a pressing signal Ss when the first driving current 11 is changed to the second driving current 12.

The controller 70 determines that the pressing of the front bumper 32 is generated according to the pressing signal Ss of the detection circuit 3215.

In step S40, when the pressing of the front bumper 32 is generated, the controller 70 generates a control signal Sc such that the number of revolutions of the motor M is changed from the first number of revolutions to the second number of revolutions. In this case, the first number of revolutions may be greater than the second number of revolutions, and the second number of revolutions may be increased according to a degree of pressing of the front bumper 32. For example, the controller 70 may generate the control signal Sc such that the second number of revolutions is increased in inverse proportion to a distance between the first surface 321 and the second surface 322.

Furthermore, the controller 70 may control a suction force of the brush 34 and/or the suction nozzle 30 at a time point desired by the user. For example, when a pressing time of the front bumper 32 lasts longer than a reference time (e.g., 0.5 second), the controller 70 may recognize a user's intention (e.g., an intention to clear an obstacle proximity zone) as a time point at which the user wants more powerful cleaning). The controller 70 may recognize the user's intention to determine a current cleaning zone as an obstacle proximity zone, and perform cleaning in an obstacle proximity zone cleaning mode.

The obstacle proximity zone cleaning mode may refer to a mode in which cleaning is performed by increasing the number of revolutions of the motor M. For example, the controller 70 may increase the number of revolutions of the motor M from the first number of revolutions to the second number of revolutions when the pressing time of the front bumper 32 lasts longer than the reference time. Accordingly, the controller 70 may improve the suction force of the brush 34 and/or the suction nozzle 30 in an obstacle proximity zone cleaning mode. In this case, the second number of revolutions may be a power mode when the first number of revolutions is a normal mode, and the second number of revolutions may be a turbo mode when the first number of revolutions is a power mode, but the embodiment is not limited thereto. Here, the normal mode is a mode in which cleaning is performed by the number of revolutions of the motor M corresponding to a case where power is supplied to the cleaner 1 for the first time, the power mode is a mode in which cleaning is performed by the number of revolutions of the motor M faster than that of the normal mode, and the turbo mode is a mode in which cleaning is performed by the maximum number of revolutions of the motor M, but the embodiment is not limited thereto.

Accordingly, the cleaner 1 according to an embodiment may recognize the user's intention to control the number of revolutions of the motor M for obstacle proximity zone cleaning at a time point desired by the user.

In step S50, the controller 70 determines whether the pressing of the front bumper 32 is released according to the pressing release signal Sr.

For example, as described with reference to FIG. 4A, the photo interrupter 3211 may be defined in a horseshoe shape in which the light-emitting element 3211a and the light-receiving element 3211b are disposed to face each other. The photo interrupter 3211 may generate a pressing release signal Sr according to the intensity of light from the light-emitting element 3211 detected by the light-receiving element 3211b, that is, the amount of light from the light-emitting element 3211a. That is, the light-receiving element 3211b may generate a pressing release signal Sr according to the light amount of the first light L1.

The controller 70 determines that the pressing of the front bumper 32 is released according to the pressing release signal Sr of the photo interrupter 3211.

In addition, as described with reference to FIG. 5A, the Hall sensor 3213 may detect a magnetic force of the magnet 3214. The magnetic force is in proportion to a distance between the Hall sensor 3213 and the magnet 3214. The Hall sensor 3213 may generate a pressing release signal Sr according to the strength of the detected magnetic force.

That is, the Hall sensor 3213 generates the pressing release signal Sr according to the detected magnetic force. For example, the Hall sensor 3213 generates a pressing release signal Sr when the detected magnetic force is the first magnetic force M1. In addition, the Hall sensor 3213 generates a pressing release signal Sr when the detected magnetic force is changed from the second magnetic force M2 to the first magnetic force M1.

The controller 70 determines that the pressing of the front bumper 32 is released according to the pressing release signal Sr of the Hall sensor 3213.

In addition, as described with reference to FIG. 6A, the detection circuit 3215 may generate a pressing signal Ss or a pressing release signal Sr according to a change in a distance between the first surface 321 and the second surface 322. For example, the detection circuit 3215 generates a pressing release signal Sr when the second driving current 12 is changed to the first driving current 11.

The controller 70 determines that the pressing of the front bumper 32 is released according to the pressing release signal Sr of the detection circuit 3215.

In step S60, when the pressing of the front bumper 32 is released, the controller 70 generates a control signal Sc such that the number of revolutions of the motor M is changed from the second number of revolutions to the first number of revolutions.

In the above, for convenience of description, it has been described that the flow of air entering the suction nozzle 30 and the rotation of the brush 34 is generated according to the same number of revolutions of the motor M, but the embodiment is not limited thereto, and the number of revolutions of the brush 34 and the number of revolutions of the motor for forming air flowing into the suction nozzle 30 may be different from each other.

In addition, for convenience of description, only a method of detecting, by the front bumper, an obstacle has been described, but the embodiment is not limited thereto, and the side bumper may also detect the obstacle with the same configuration as the front bumper

In addition, although the embodiments have been described in detail, the scope of rights of the embodiments is not limited thereto, and various modifications and improvements of those skilled in the art using the basic idea of the embodiments defined in the claims below also belong to the scope of rights of the embodiments.

Accordingly, the foregoing detailed description should not be construed as restrictive in all aspects but considered as illustrative. The scope of the present disclosure should be determined by rational interpretation of the appended claims, and all changes within the scope of equivalents of the present disclosure are included in the scope of the present disclosure.

[Reference Signs List]
1: Cleaner 10: Cleaner body
12: Dust container 13: Handle
20: Extension tube 30: Suction nozzle
31: Case 32: Front bumper
33: Side bumper 34: Brush
321: First side 322: Second side
32111: Photo interrupter 3212: Light-blocking material
3214: Magnet 3215: Detection circuit

1. A cleaner comprising a suction nozzle and a handle, the cleaner being moved by means of the handle,
wherein the suction nozzle comprises a bumper and a brush,
wherein the bumper is composed of a first surface and a second surface and is disposed outside the nozzle,
wherein the second surface is disposed apart from the first surface by a first distance, and
wherein a number of revolutions of the brush and a suction force of the cleaner are controlled according to the first distance that changes in response to the pressing of the bumper.

2. The cleaner of claim 1, wherein the cleaner further comprises a motor and a controller,
wherein the motor controls at least one of a number of revolutions of the brush and a suction force of the cleaner according to a control signal of the controller,
wherein the suction nozzle generates a pressing signal of the bumper when the first distance is changed to a second distance according to the pressing of the first surface, and generates a pressing release signal of the bumper when a distance between the first surface and the second surface is changed from the second distance to the first distance,
wherein the controller generates the control signal such that the number of revolutions becomes a first number revolutions according to the pressing signal and the number of revolutions becomes a second number of revolutions according to the pressing release signal, and
wherein the pressing of the first surface is in proportion to a distance moved by means of the cleaner using the handle, the second distance is narrower than the first distance, and the first number of revolutions is larger than the second number of revolutions.

3. The cleaner of claim 2, wherein a photo interrupter is disposed on the first surface, and the photo interrupter is defined in a horseshoe shape including a space therebetween,
wherein a light-blocking material is disposed at a position corresponding to the space on the second surface,
wherein the light-blocking material does not enter the space at the first distance and at least part thereof enters the space at the second distance, and
wherein the photo interrupter generates the pressing signal in response to the first distance and generates the pressing release signal in response to the second distance.

4. The cleaner of claim 3, wherein the photo interrupter comprises a light-emitting element and a light-receiving element, and the space is defined between the light-emitting element and the light-receiving element, and
wherein the photo interrupter generates the pressing signal or the pressing release signal according to an amount of light of the light-emitting element detected by the light-receiving element.

5. The cleaner of claim 4, wherein the photo interrupter detects a first amount of light from the light-emitting element at the first distance, detects a second amount of light from the light-emitting device at the second distance, generates the pressing signal according to the first amount of light, and generates the pressing release signal according to the second amount of light, and
wherein the first amount of light is less than the second amount of light.

6. The cleaner of claim 5, wherein the photo interrupter generates the pressing signal when the first amount of light is changed to the second amount of light, and generates the pressing release signal when the second amount of light is changed to the first amount of light.

7. The cleaner of claim 2, wherein a Hall sensor is disposed on the first surface, wherein a magnet is disposed at a position corresponding to the Hall sensor on the second surface,
wherein the Hall sensor detects a first magnetic force corresponding to the first distance and a second magnetic force corresponding to the second distance, and generates the pressing release signal in response to the first magnetic force and generates the pressing signal in response to the second magnetic force, and
wherein the strength of the second magnetic force is stronger than that of the first magnetic force.

8. The cleaner of claim 7, wherein the Hall sensor further generates the pressing signal when the first magnetic force is changed to the second magnetic force, and generates the pressing release signal when the second magnetic force is changed to the first magnetic force.

9. The cleaner of claim 8, wherein the bumper comprises a detection circuit,
wherein the detection circuit comprises a switch that performs a switching operation according to a degree of pressing of the bumper, and
wherein the detection circuit generates the pressing signal and the pressing release signal according to the magnitude of a current flowing through the switch.

10. The cleaner of claim 9, wherein the switch performs a switching operation such that the current becomes a first current flowing through a first path in response to the first distance, and performs a switching operation such that the current becomes a second current flowing through a second path in response to the second distance,
wherein the detection circuit further generates the depressing release signal in response to the first current and generates the pressing signal in response to the second current, and
wherein the intensity of the second current is lower than that of the first current.

11. The cleaner of claim 10, wherein the detection circuit further generates the pressing signal when the first current is changed to the second current, and generates the pressing release signal when the second current is changed to the first current.

12. A suction nozzle of a cleaner comprising a handle and a bumper, the cleaner being moved to the handle,
wherein the bumper is composed of a first surface and a second surface and is disposed outside the suction nozzle,
wherein the second surface is disposed apart from the first surface by a first distance,
wherein the suction nozzle sucks outside air according to a suction force generated in response to a predetermined number of revolutions, generates a pressing signal of the bumper when the first distance is changed to a second distance according to the pressing of the first surface, and generates a pressing release signal of the bumper when a distance between the first surface and the second surface is changed from the second distance to the first distance, and
wherein the number of revolutions becomes a first number of revolutions according to the pressing signal and the number of revolutions becomes a second number of revolutions according to the pressing release signal, the pressing of the first surface is in proportion to a distance by which the cleaner moves using the handle, the first surface is formed of a flexible material, the second distance is narrower than the first distance, and the first number of revolutions is larger than the second number of revolutions.

13. The suction nozzle of claim 12, wherein a photo interrupter is disposed on the first surface, and the photo interrupter is defined in a horseshoe shape including a space therebetween,
wherein a light-blocking material is disposed at a position corresponding to the space on the second surface,
wherein the light-blocking material does not enter the space at the first distance and at least part thereof enters the space at the second distance, and
wherein the photo interrupter generates the pressing signal in response to the first distance and generates the pressing release signal in response to the second distance.

14. The suction nozzle of claim 13, wherein the photo interrupter comprises a light-emitting element and a light-receiving element, and the space is defined between the light-emitting element and the light-receiving element, and
wherein the photo interrupter generates the pressing signal or the pressing release signal according to an amount of light of the light-emitting element detected by the light-receiving element.

15. The suction nozzle of claim 14, wherein the photo interrupter detects a first amount of light from the light-emitting element at the first distance, detects a second amount of light from the light-emitting device at the second distance, generates the pressing signal according to the first amount of light, and generates the pressing release signal according to the second amount of light, and
wherein the first amount of light is less than the second amount of light.

16. The suction nozzle of claim 15, wherein the photo interrupter generates the pressing signal when the first amount of light is changed to the second amount of light, and generates the pressing release signal when the second amount of light is changed to the first amount of light.

17. The suction nozzle of claim 12, wherein a Hall sensor is disposed on the first surface,
wherein a magnet is disposed at a position corresponding to the Hall sensor on the second surface,
wherein the Hall sensor detects a first magnetic force corresponding to the first distance and a second magnetic force corresponding to the second distance, and generates the pressing release signal in response to the first magnetic force and generates the pressing signal in response to the second magnetic force, and
wherein the strength of the second magnetic force is stronger than that of the first magnetic force.

18. The suction nozzle of claim 17, wherein the Hall sensor further generates the pressing signal when the first magnetic force is changed to the second magnetic force, and generates the pressing release signal when the second magnetic force is changed to the first magnetic force.

19. The suction nozzle of claim 18, wherein the bumper comprises a detection circuit,
wherein the detection circuit comprises a switch that performs a switching operation according to a degree of pressing of the bumper, and
wherein the detection circuit generates the pressing signal and the pressing release signal according to the magnitude of a current flowing through the switch.

20. The suction nozzle of claim 19, wherein the switch performs a switching operation such that the current becomes a first current flowing through a first path in response to the first distance, and performs a switching operation such that the current becomes a second current flowing through a second path in response to the second distance,
wherein the detection circuit further generates the pressing release signal in response to the first current, generates the pressing signal in response to the second current, generates the pressing signal when the first current is changed to the second current, and generates the pressing release signal when the second current is changed to the first current, and
wherein the intensity of the second current is lower than that of the first current.
